(19) United States
(12) Patent Application Publication
(10) Pub. No.: US 2010/0013262 A1
(43) Pub. Date: Jan. 21, 2010

(54) Sunshade for motor vehicles

(76) Inventor: Randi R. Shu, Harrison, NJ (US)

Correspondence Address: DILWORTH & BARRESE, LLP, 1000 WOODBURY ROAD, SUITE 405, WOODBURY, NY, 11797, US

(21) Appl. No.: 12/218,696

(22) Filed: Jul. 17, 2008

(51) Int. Cl. B60J 3/00

(52) U.S. Cl. 296/97.8

(57) ABSTRACT

A sunshade assembly includes a housing, the housing enclosing a lengthwise interior space and including a lengthwise slot extending between the interior space and an outer surface of the housing; and a sunshade apparatus disposed within the housing and including a sheet of shade material wound upon a roller and unwindable therefrom to an extended position. The sheet of shade material is biased to a wound configuration around the roller and is extendible through the slot. A leading edge of the shade material includes a support bar attached thereto. The support bar is disposed outside of the housing and is configured and dimensioned so that it cannot be withdrawn through the slot into the housing. Also provided herein is a kit for mounting the sunshade assembly to an interior surface of a vehicle.

### BACKGROUND

1. Field of the Invention

The present invention is related to sunshades, and particularly to sunshades mounted at the front or rear windshields to shield the interior of a motor vehicle, particularly an automobile cabin, from sunlight.

2. Background of the Art

Vehicles parked in unshaded areas are exposed unprotected with respect to the direct sun light of the sun's rays. In certain cases, when the vehicle doors and windows are shut, the internal temperatures can build up to severely high levels resulting in danger to helpless persons, children, and animals, e.g., pets left in such vehicles are subject to suffering heat stroke, dehydration, suffocation, and even death. Even when there are no children or pets in the vehicle there is risk of damage to electronic items and articles which are not designed to withstand the temperatures within the cabin of the automobile. On a hot summer day the interior of a car in direct sunlight can reach a temperature of up to 200° F. in direct sunlight. Consequently, various attempts are made to ameliorate this condition. Most vehicle drivers try to park under a tree which offers shade tending to keep the temperature of the interior vehicle below harmful levels. Another solution has been the use of removable sunshades.

Various types of sunshades for automobiles are known. Such sunshades are typically panels of, for example, reflective material mounted at the front dashboard to block sunlight from the front windshield, or at the rear shelf to block sunlight from the rear windshield. Other sunshades are mounted to the exterior of the vehicle.

For example U.S. Pat. No. 5,039,159 to Bonner discloses a sunshade/shield installed on the roof of a vehicle and comprises a substantially rectangular panel which is attachable to the luggage rack of an automobile.

U.S. Pat. No. 5,038,844 to Edmonds et al. discloses an opaque, detachable automobile window shade for covering the inside surface of a vehicle windshield, roof window, dashboard and the like. The window shade includes a contoured sheet of pliable material of substantially the same size and shape of the windshield surface intended to be covered. A dashboard sheet and a roof window sheet are provided for covering other areas of the vehicle interior. A hook and pile fastener is carried along the edge marginal region of the shade with various sheets constituting sunshades. The window sills and dash areas include fasteners for detachably mounting the shade sheets across the inside of the respective window and dash areas. Reinforcement is included at each fastener location on the shade and a tab on the fastener permits grasping by the user for manual disengagement for removal of the shade.

While various types of internal and external shades are known there is yet a need for an inexpensive shade which is easily deployed and effective at blocking the sunlight entering at the glass surfaces of an automobile or other such vehicle.

### SUMMARY

A sunshade assembly is provided herein, the sunshade assembly comprising (a) a housing for a sunshade apparatus, the housing enclosing a lengthwise interior space and including a lengthwise slot extending between the interior space and an outer surface of the housing; and (b) a sunshade apparatus disposed within the housing and including a sheet of shade material wound upon a roller and unwindable therefrom to an extended position, the sheet of shade material being biased to a wound configuration around the roller, the sheet of shade material being extendible through the slot and having a leading edge and a support bar attached to the leading edge, the support bar being disposed outside of the housing and being configured and dimensioned so that it cannot be withdrawn through the slot into the housing.

Also provided herein is a kit including the sunshade assembly, a retainer for the sunshade assembly, means for mounting the retainer to the interior surface of a vehicle, and means for maintaining the shade material in the extended position.

The invention advantageously provides a sunshade for a motor vehicle such as a bus, truck, or automobile, which is convenient, inexpensive and saves space in the interior of the vehicle.

### BRIEF DESCRIPTION OF THE DRAWINGS

Various embodiments are described below with reference to the drawings wherein:

FIG. 1 is a perspective view of a sun-shade assembly;

FIG. 2 is a sectional view of the sunshade assembly;

FIG. 3 is a perspective view of a retainer for the sunshade assembly;

FIG. 4 is an alternative embodiment of the retainer for the sunshade assembly;

FIG. 5 is an elevational view illustrating the use of the sunshade assembly in a vehicle;

FIG. 6 is a plan view of two sunshade assemblies installed on the dashboard of a vehicle;

FIG. 7 illustrates an alternative embodiment of the means for holding the shade material in an extended position;

FIG. 8 is a perspective view of an attachment member with an adapter pad for mounting to a curved surface such as a windshield; and

FIG. 9 is a plan view of two sunshade assemblies mounted to a windshield employing the attachment members with adapter pads.

### DETAILED DESCRIPTION OF PREFERRED EMBODIMENT(S)

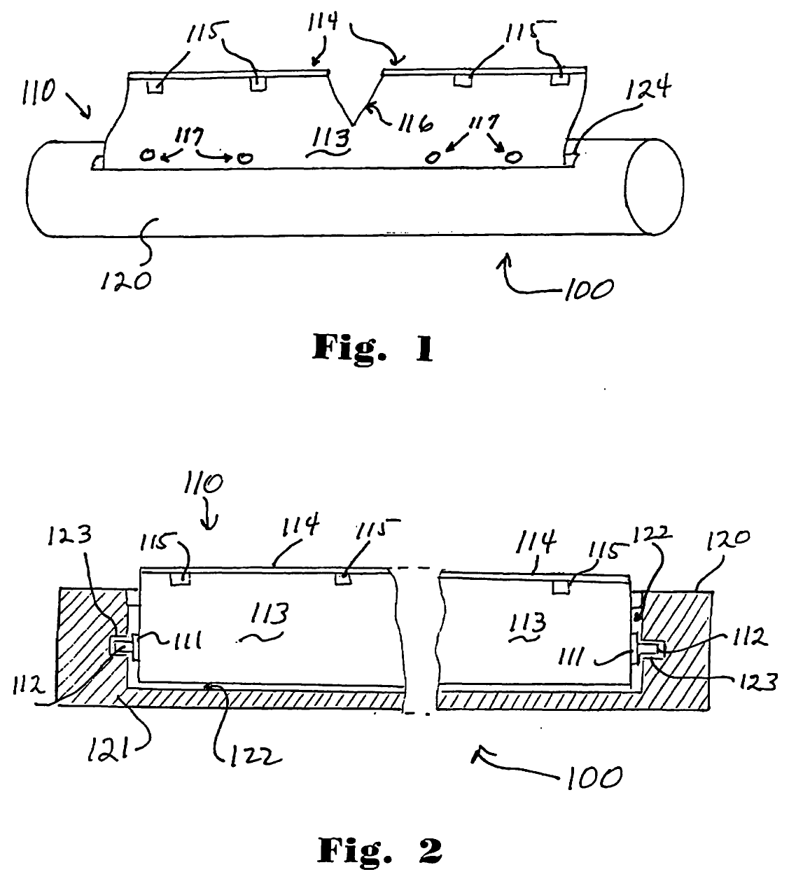

FIGS. 1 and 2 illustrate the sunshade assembly 100 of the invention which includes a sunshade 110 disposed within a housing 120.

More particularly, sunshade 110 includes a sheet of shade material 113 removably coiled around a roller 111. Spindles 112 extend axially outward at both ends of the roller 111. The shade material 113 can be any type of flexible sheet material capable of blocking sunlight, such as fabric, polymeric film, and the like. Preferably, the shade material provides protection against ultraviolet light. Optionally, the shade material 113 can have a reflective coating. Alternatively, the shade material can be opaque, translucent, or semi-transparent as long as at least some of the sunlight shining upon it is prevented from passing through it, preferably by reflection. In an embodiment, the shade material 113 can have indicia, images, and/or other visually observable printing on one side.

The sunshade material 113 is preferably spring loaded by conventional means such that it is biased to a wound configuration around the roller 111. Thus, in a preferred embodiment of the invention the sunshade is self-winding and retracts into the housing 120 unless prevented by holding means such as hooks (described below). The sunshade includes a support bar 114 at the leading edge of the shade material 113, which can be divided as shown in FIG. 1 to accommodate the rear view mirror 154 of a car, as explained below. Also, the shade material 113 preferably includes a recess such as V-shaped notch 116 to accommodate the rear view mirror 154, as described below. The leading end of the shade material 113 preferably includes openings 115 for reception therethrough of the holding means (e.g., hooks 155, described below). Optionally, the shade material 113 can include one or more button stoppers 117 removably attached to the shade material 113 in the vicinity of the leading edge of thereof. Button stoppers 117 are configured and dimensioned to be larger than the width of lengthwise aperture 124 described below so as to prevent retraction of the leading edge of the shade material 113 into the housing 120.

Housing 120 for the sunshade 110 includes body 121 defining a lengthwise interior space 122 in which the sunshade 110 is disposed. Body 121 can be fabricated from any material suitable for the purposes described herein such as synthetic polymer, metal or wood. In a preferred embodiment body 121 is fabricated from an engineering plastic such as polycarbonate, acrylic, polyvinyl chloride, and the like. Recesses 123 in the housing 120 at each of the interior space 122 are adopted to receive spindles 112 as illustrated in FIG. 2. Housing 120 includes an upper lengthwise extending aperture 124 through which the shade material 133 can be withdrawn from housing 120. The leading edge of the shade material at support bar 114 is always exterior to the housing 120 so as to be easily grasped by the user. For example, the sheet of shade material 113 can be of such length that it cannot be entirely withdrawn into the interior 122 of the housing. Alternatively, the bar 114 can have a length or diameter greater than that of aperture 124 to prevent it from passing therethrough. Or, as indicated above, the shade material 113 can include one or more button stoppers 117 which prevent the shade material 113 from being further retracted through aperture 124 into the housing 120.

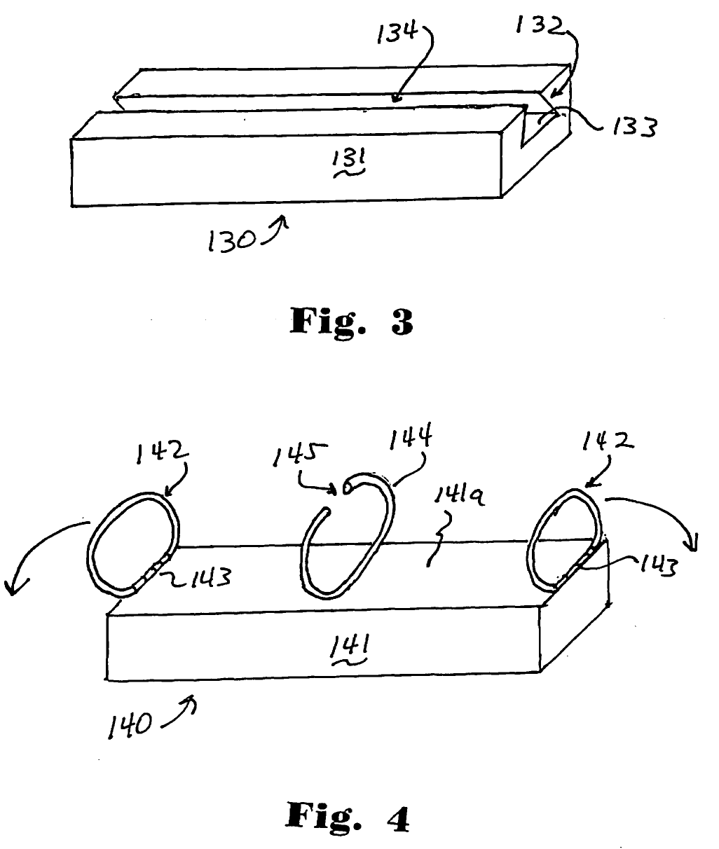

Referring now to FIG. 3, a retainer 130 for the sunshade assembly 100 is shown in perspective view. Retainer 130 is adapted to be mounted to the dashboard or rear shelf of an automobile or any suitable surface in the vicinity of a windshield or window. Retainer 130 includes an elongated body 131 having a notch 132 configured such that the bottom surface 133 of the notch 132 is wider than the upper opening 134 of the notch 132. The sunshade assembly 100 is inserted lengthwise into notch 132 through one of the ends such that the lending end of the shade material (e.g., support bar 114) extends outwardly from opening 134. The diameter of the sunshade housing 120 is smaller than the width of bottom surface 133, but larger than the width of opening 134. As can be readily appreciated, the sunshade assembly 100 is held by retainer 130 while the shade material 113 is withdrawn.

Referring now to FIG. 4, an alternative embodiment 140 of the retainer is illustrated. Retainer 140 includes a base 141 which is adapted to be attached to the dashboard or rear shelf of an automobile, or any suitable surface in the vicinity of a window. Retainer 140 includes two end rings 142 each mounted to a respective end of base 141 on the top surface 141a thereof. The end rings 142 are mounted by means of respective hinges 143. As can be seen from FIG. 4, end rings 142 can be rotated on hinges 143 to facilitate mounting thereto of the sunshade assembly 100 as explained below. Optionally, the end rings 142 are spring biased to the upright position. Optionally, a middle ring 144 can be fixed to the top 141a of base 141 in the vicinity of the center thereof. Middle ring 144 includes a gap 145 to permit the shade material 113 to be drawn therethrough.

End rings 142 do not require a gap because the retainer 140 is configured and dimensioned such that the end rings 142 do not surround the sunshade housing 120 within the lengthwise extension of upper aperture 124.

To mount the sunshade assembly 100 to retainer 140, the end rings 142 are turned outward and down as shown by the arrows in FIG. 4. The sunshade assembly 100 is then slid through center ring 144 with upper aperture 124 of the housing aligned with gap 145. When the housing 120 has been properly centered on base 141 the end rings 142 are turned back upwards around and over the respective ends of the housing body 121. Alternatively, the end rings 142 are spring biased to the upright position and automatically return to the upright position when released. The sunshade assembly 100 will then be prevented from being pulled off retainer 140 when the shade material 113 is pulled out the housing 120.

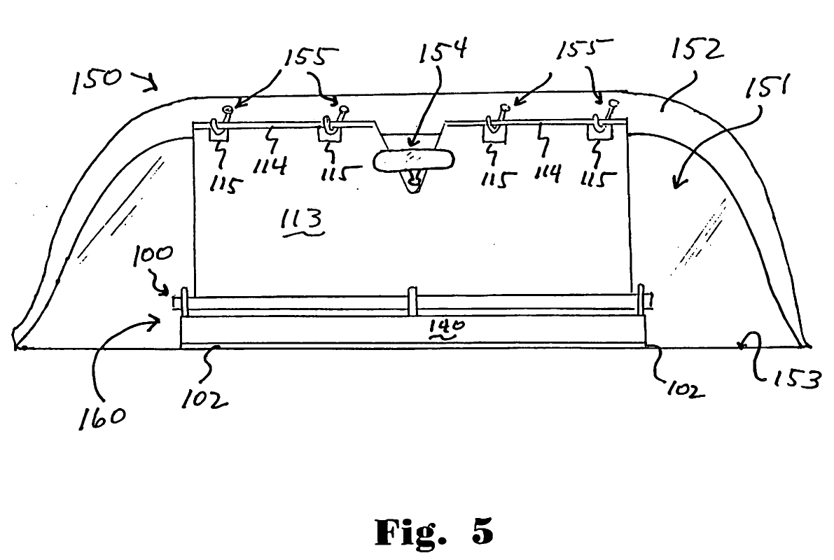

Referring now to FIG. 5, the mounting of the sunshade assembly 100 in an automobile 150 is illustrated. Preferably, the sunshade assembly is provided in conjunction with a kit 160 including at least one mounting strip 102, a retainer 130 or 140 (FIG. 5 illustrates retainer 140, but retainer 130 can alternatively be used), the sunshade assembly 100 and a plurality of hooks 155.

Mounting strip 102 can be an adhesive strip which attaches to the dashboard 153 of the automobile 150 behind windshield 151. In one embodiment the mounting strip 102 can include a double sided adhesive strip with one side attached to the dashboard 153 and the other side attached to the bottom of retainer 140. In another embodiment the mounting strip 102 can include one adhesive side attached to the dashboard 153. The other side can include a hook and loop type fastener (e.g., Velcro® type fastener) with the corresponding hook and loop type fastening strip being affixed to the bottom of the retainer 140. The hook and loop type fastener arrangement enables the sunshade assembly and retainer to be easily removed from the dashboard.

Hooks 155 are attachable to the interior surface of the frame 152 above the windshield. Hooks 155 can be adhesively attached to frame 152 and are spaced apart so as to align with apertures 115 of the shade material 113.

The retainer 140 is mounted to the mounting strip 102 and is positioned behind and substantially aligned with the windshield 151.

The sunshade assembly 100 is mounted to the retainer 140 as described above. To use the sunshade of the invention the edge support bar 114 is grasped by the user and pulled upward. With the sunshade assembly 100 properly oriented with respect to the windshield 151 the V-shaped notch 116 is aligned with rear view mirror 154 so that the sheet of shade material 113 can be drawn up under and around the rear view mirror 154 instead of over it, as shown in FIG. 5. The leading edge of the shade material 113 is mounted to the hooks 155 such that each hook 155 is disposed through a respective aperture 115 and supports the support bar 114.

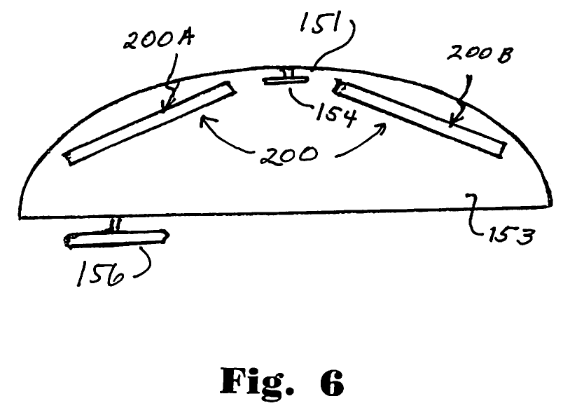

Referring now to FIG. 6, an alternative embodiment of the invention is illustrated in plan view with kit 200 mounted to dashboard 153 and shown in relation to windshield 151, rear view mirror 154 and steering wheel 156. Kit 200 includes two sub-assemblies 200A and 200B, each sub-assembly including a respective mounting strip (e.g., 102), retainer (e.g., 140), sunshade assembly (e.g., 100), and hooks (e.g., 155) or Velcro® type fasteners as described below. Kit 200 is advantageously used to accommodate curved windshields because each sub-assembly 200A and 200B is positioned at an angle to the other sub-assembly with a gap between them, thus more closely conforming to the curvature of the windshield. The gap between the subassemblies 200A and 200B is aligned with the rear view mirror 154. The V-shaped notch is not needed in the sunshade material because, the sub-assemblies 200A and 200B are not mounted under the rear view mirror 154. When the sunshade is deployed the sheets of sunshade material 113 extend along the sides of the rear view mirror 154.

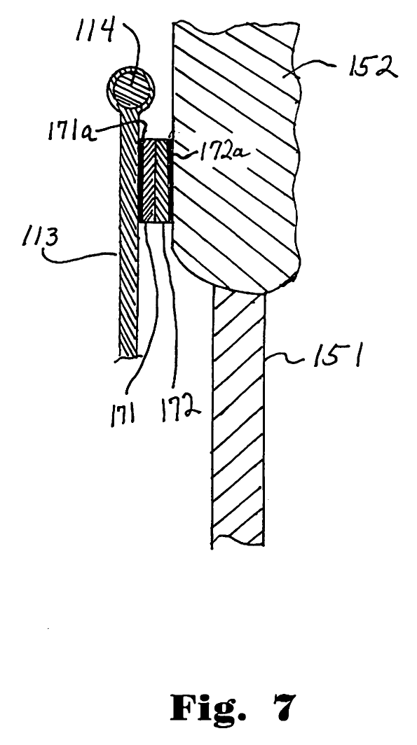

Referring now to FIG. 7, an alternative means for holding the shade material 113 in the extended position is illustrated. Instead of using hooks 155 to hold up the shade material 113 or apertures 155 in the shade material 113 to receive the hooks 155, a hook and loop type fastener system (Velcro®) can be employed. For example, one layer of Velcro® material 171 can be attached to shade material 113 by means of an adhesive layer 171a. The corresponding layer of Velcro® material 172 can be attached by adhesive layer 172a to the interior surface of the frame 152. Thus, the shade material can be easily pulled out to the extended position, and removably attached to the frame 152 without having to individually insert hooks into apertures. Removal of the shade material is easy, and upon release the shade material 113 automatically retracts into the housing 120.

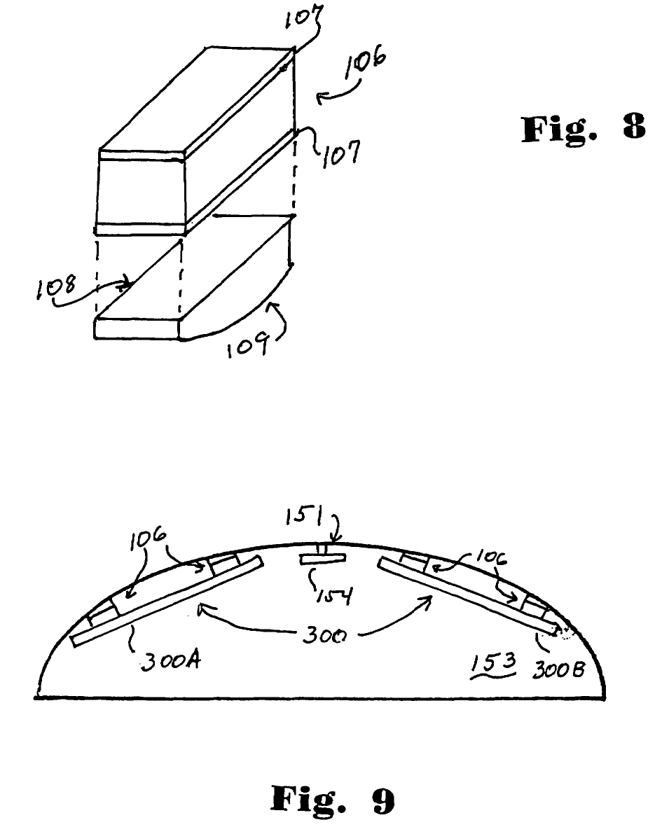

Referring now to FIGS. 8 and 9, attachment members 106 are provided to secure the subassemblies 300A and 300B of kit 300 to either the dashboard 153 or the windshield 151. Kit 300 includes two sub-assemblies 300A and 300B, each sub-assembly including respective attachment members 106, retainer (e.g., 140), sunshade assembly (e.g., 100), and hooks (e.g., 155) or Velcro® type fasteners as described above. As with the previously described embodiment, kit 300 is advantageously used to accommodate curved windshields because each sub-assembly 300A and 300B is positioned at an angle to the other sub-assembly with a gap between them, thus more closely conforming to the curvature of the windshield. The gap between the subassemblies 300A and 300B is aligned with the rear view mirror 154. The V-shaped notch is not needed in the sunshade material because, the sub-assemblies 300A and 300B are not mounted under the rear view mirror 154. When the sunshade is deployed the sheets of sunshade material 113 extend along the sides of the rear view mirror 154.

Attachment members 106 each include two adhesive surfaces 107 on opposite sides. To attach the subassembly to the dashboard the attachment member 106 is mounted to the dashboard on one of the surfaces 107 with the subassembly mounted to the attachment member on the other of the adhesive surfaces. Preferably, attachment members 106 are relatively short and are spaced apart from each other with the retainer 140 extending across the attachment members 106. However, kit 300 also includes adaptor pads 108, each having an outer curved adhesive surface 109 configured to conform to the curve of a windshield. To mount the subassembly to the windshield the adaptor pad 108 is attached at its flat side 108a to an adhesive surface 107 of the attachment member 106. The curved outer surface 109 is mounted to the windshield 151 and a side of the retainer 140 is mounted to the other adhesive surface 107 of the attachment member 106.

While the above description contains many specifics, these specifics should not be construed as limitations of the invention, but merely as exemplifications of preferred embodiments thereof. For example, adhesive surfaces can be covered by release liners which are removed by the user prior to mounting to a surface. Those skilled in the art will envision many other embodiments within the scope and spirit of the invention as defined by the claims appended hereto.

What is claimed is:

1. A sunshade assembly comprising:
a) a housing for a sunshade apparatus, said housing enclosing a lengthwise interior space and including a lengthwise slot extending between the interior space and an outer surface of the housing; and
b) a sunshade apparatus disposed within the housing and including a sheet of shade material wound upon a roller and unwindable therefrom to an extended position, said sheet of shade material being biased to a wound configuration around said roller, said sheet of shade material being extendible through said slot and having a leading edge and means to prevent the leading edge from being retracted through the slot and into the housing.

2. The sunshade assembly of claim 1 wherein the housing is fabricated from a synthetic resin selected from polycarbonate, acrylic and polyvinyl chloride.

3. The sunshade assembly of claim 1 wherein the shade material includes a notch in the leading edge thereof.

4. The sunshade assembly of claim 1 wherein the shade material is a fabric or a polymeric film.

5. The sunshade assembly of claim 1 wherein the shade material is at least partially reflective.

6. The sunshade assembly of claim 1 wherein the means to means to prevent the leading edge from being retracted through the slot and into the housing comprises one or more button stoppers removably attached to the sheet of shade material.

7. A sunshade kit for a vehicle which comprises:
a) at least one sunshade assembly including,
i. an elongated housing for a sunshade apparatus, said housing enclosing a lengthwise interior space and including a lengthwise slot extending between the interior space and an outer surface of the housing; and
ii. a sunshade apparatus disposed within the housing and including a sheet of shade material wound upon a roller and unwindable therefrom to an extended position, said sheet of shade material being biased to a wound configuration around said roller, said sheet of shade material being extendible through said slot and having a leading edge and means to prevent the leading edge from being retracted through the slot and into the housing;
b) at least one retainer for holding the sunshade assembly;
c) at least one mounting strip which is attachable on one side to an interior surface of the vehicle and on the other side to a bottom surface of the retainer; and,
d) at least one means for holding the sheet of shade material in the extended position.

8. The sunshade kit of claim 7 wherein the housing is fabricated from a synthetic resin selected from polycarbonate, acrylic and polyvinyl chloride.

9. The sunshade kit of claim 7 wherein the shade material includes a notch in the leading edge thereof.

10. The sunshade kit of claim 7 wherein the shade material is a fabric or a polymeric film.

11. The sunshade kit of claim 7 wherein the shade material is at least partially reflective.

12. The sunshade kit of claim 7 wherein the means to prevent the leading edge from being retracted into the housing comprises one or more button stoppers attached to the shade material.

13. The sunshade kit of claim 7 wherein the shade material includes a plurality of openings in the vicinity of the leading edge.

14. The sunshade kit of claim 7 wherein the retainer comprises an elongated body having a lengthwise extending notch in an upper surface of the retainer, said notch including a lengthwise opening and a lengthwise bottom surface which is wider than the lengthwise opening, said lengthwise notch being configured and dimensioned to receive the sunshade assembly in a space between the lengthwise opening and the lengthwise bottom surface, the lengthwise opening of the notch having a width less than that of the housing but greater than the thickness of the shade material so as to permit withdrawal of the shade material from the housing through the lengthwise opening while preventing the housing from being dislodged from the retainer.

15. The sunshade kit of claim 7 wherein the retainer comprises:
an elongated body having an upper surface and first and second opposite ends,
first and second rings, each being hingedly attached to the elongated body in the vicinity of a respective one of the first and second ends and rotatably movable between an outward position and an upright position,
wherein the distance between the first and second rings in the upright position is less than the length of the housing but greater than the length of the slot in the housing.

16. The sunshade kit of claim 15 wherein the retainer comprises a third ring fixedly positioned on the upper surface of the body between the first and second rings and including a gap at the top thereof to permit the passage of the shade material therethrough.

17. The sunshade kit of claim 7 wherein the mounting strip includes first and second opposite sides, each side being adhesive.

18. The sunshade kit of claim 7 wherein the mounting strip includes first and second opposite sides, the first side being adhesive and the second side having one layer of hook or loop type fasteners, wherein the bottom surface of the retainer includes a corresponding layer of hook or loop type fasteners such that the retainer can be removably mounted to the mounting strip.

19. The sunshade kit of claim 7 wherein the means for holding the sheet of shade material in the extended position comprises a plurality of hook members attachable to an interior surface of the vehicle.

20. The sunshade kit of claim 7 wherein the means for holding the sheet of shade material in the extended position comprises first and second cooperating layers of hook and loop type fasteners, one of said first and second layers being attached to a surface of the shade material and the other of the first and second layers being attached to an interior surface of the vehicle.

21. The sunshade kit of claim 7 including a second sunshade assembly, a second retainer, a second mounting strip and second means for holding the sheet of shade material in the extended position.
